(19) United States
(12) Patent Application Publication
(10) Pub. No.: US 2007/0149405 A1
(43) Pub. Date: Jun. 28, 2007

(54) Rare earth compositions and structures for removing phosphates from water

(75) Inventor: Timothy M. Spitler, Fernley, NV (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Altair Nanomaterials, Inc., Reno, NV (US)

(21) Appl. No.: 10/536,856

(22) PCT Filed: Dec. 2, 2003
(86) PCT No.: PCT/US03/38235

§ 371 Date: Nov. 22, 2006

Related U.S. Application Data
(60) Provisional application No. 60/430,284, filed on Dec. 2, 2002.

(51) Int. Cl. A01N 59/00; C01F 17/00

(52) U.S. Cl. 504/151; 423/263; 977/902

(57) ABSTRACT

A rare-earth compound selected from the group consisting of rare earth anhydrous oxycarbonate and rare earth hydrated oxycarbonate, with a surface area of at least 10 m²/g, suitable for the removal of phosphate from water.

The present invention is a continuation-in-part application of U.S. Ser. No. 60/430,284 filed Dec. 2, 2002, the entire contents of which are incorporated herein by reference.

The present invention relates to a chemical composition and a physical structure of a chemical compound, used to efficiently remove phosphates from water. Particularly, the invention relates to the use of rare-earth compounds to control algal growth in swimming pools and other water systems. More particularly, the invention relates to lanthanum compounds. The description of the invention is based on the use of lanthanum. It is to be understood that other rare-earth elements can be substituted for lanthanum.

### BACKGROUND OF THE INVENTION

Traditional algal control in swimming pools and other water systems is achieved by biocides. This generally requires substantial amounts of toxic chemicals.

New methods that have recently been developed are based on the removal of phosphate, an indispensable nutrient for algal growth, from the water. Several methods and compositions based on lanthanum compounds have recently been proposed for the removal of phosphate from water to control algal growth. U.S. Pat. No. 6,146,539 discloses a treatment method for swimming pool water based on the addition of finely divided, insoluble, lanthanum carbonate or of soluble lanthanum chloride. The lanthanum carbonate reaction is typically slow, and several days are required to see an effect in practice. Lanthanum chloride produces a milky precipitate that can only be removed by the addition of copious amounts of flocculent. Making styrene-based ion-exchange beads incorporating lanthanum carbonate was also effective but slow: in one example, it took 4 days to reduce the phosphate concentration from 400 to 30 ppb.

U.S. Pat. No. 6,312,604 uses a polymer e.g. polyacrylamide or polyvinyl alcohol with a binder to attach a lanthanide halide salt, preferably La chloride. This method prevents the formation of very fine precipitate, but the reaction rates are also very slow.

A method that has been proposed to accelerate the rate of formation of lanthanum phosphate is to use a compound with intermediate solubility, such as lanthanum sulfate, either alone or in combination with La carbonate. Such method is disclosed in U.S. Pat. No. 6,338,800. One drawback of the method is that excess lanthanum sulfate will leave lanthanum in solution.

Lanthanum oxycarbonates have recently been disclosed to remove phosphate from the gastrointestinal tract and the bloodstream in patients with hyperphosphatemia. We have now found that the properties of lanthanum oxycarbonates can also be applied to efficiently remove phosphates from water to very low levels.

### SUMMARY OF THE INVENTION

In accordance with the present invention, rare-earth compounds, and in particular, rare earth oxycarbonates are provided. The oxycarbonates may be hydrated or anhydrous. These compounds may be produced according to the present invention as particles having a porous structure. The rare-earth compound particles of the present invention may conveniently be produced in a controllable range of surface areas with resultant variable and controllable adsorption or chemical reaction rates of the phosphate ion.

It has now been found that the properties of lanthanum oxycarbonate can provide unexpected advantages over lanthanum carbonate, lanthanum halides (particularly chloride) and lanthanum sulfate for the removal of phosphate from water for the prevention of algal growth. The lanthanum compounds of this invention are lanthanum oxycarbonates, particularly La₂O(CO₃)₃.4H₂O and La₂O₂CO₃. These compounds can be made by any method.

A method of making lanthanum oxycarbonate hydrate particles includes making a solution of lanthanum chloride, subjecting the solution to a slow, steady feed of a sodium carbonate solution at a temperature between about 30° C. and about 90° C. while mixing, then filtering and washing the precipitate, then drying the filter cake at a temperature between about 100° C. and about 120° C. to produce the desired lanthanum oxycarbonate hydrate species. Optionally, the filter cake may be dried then slurried and milled in a horizontal or vertical pressure media mill to a desired surface area, spray dried or dried by other means to produce a powder that may be washed, filtered and dried.

Another method of making the anhydrous lanthanum oxycarbonate particles includes making a solution of lanthanum chloride, subjecting the solution to a slow, steady feed of a sodium carbonate solution at a temperature of about 30° C. to 90° C. while mixing, then filtering and washing the precipitate, then drying the filter cake at a temperature between about 100° C. and 120° C. to produce the desired lanthanum oxycarbonate hydrate species. Then the dried filter cake is subjected to a thermal treatment at a temperature between 400° C. to 700° C. Optionally, the product of the thermal treatment may be slurried and milled in a horizontal or vertical pressure media mill to a desired surface area, spray dried or dried by another means to produce a powder that may be washed, filtered and dried.

Still another method of making anhydrous lanthanum oxycarbonate particles includes making a solution of lanthanum acetate, subjecting the solution to a total evaporation process using a spray dryer or other suitable equipment to make an intermediate product, and calcining the intermediate product obtained at a temperature between about 500° and about 1200° C. The intermediate product of the calcination step may be washed, filtered and dried to make a suitable final product. Optionally the intermediate product may be milled in a horizontal or vertical pressure media mill to a desired surface area, spray dried or dried by other means to produce a powder that may be washed, filtered and dried.

The porous particles or porous structures of the present invention are made of nano-sized to micron-sized crystals. The lanthanum oxycarbonate hydrate is preferably lanthanum oxycarbonate tri or tetra hydrate (La₂O(CO₃)₂.xH₂O where 2≦x≦4, including where x is 3 or 4. The preferred anhydrous lanthanum oxycarbonate is La₂O₂CO₃, also written as (LaO)₂CO₃ or La₂CO₅, of which several crystalline forms exist.

### BRIEF DESCRIPTION OF THE DRAWINGS

FIG. 1 is a general flowsheet of a process according to the present invention that produces lanthanum oxycarbonate tri or tetra hydrate (La₂O(CO₃)₂.xH₂O), with where 2≦x≦4, including where x is 3 or 4.

FIG. 2 is a scanning electron micrograph of a lanthanum oxycarbonate La₂O(CO₃)2.xH₂O (where 2≦x≦4, including where x is 3 or 4) porous structure made according to the process of the present invention and magnified 120,000 fold.

FIG. 3 is an XRD scan of lanthanum oxycarbonate hydrate (La₂O(CO₃)2.xH₂O) wherein where 2≦x≦4, including where x is 3 or 4 and generally close to 4 and wherein the lanthanum oxycarbonate hydrate is made according to the process of the present invention and compared with a standard library card of La₂O(CO₃)2.xH₂O.

FIG. 4 is a general flow sheet of a process according to the present invention that produces anhydrous lanthanum oxycarbonate ((LaO)₂CO₃ or La₂CO₅, of which several crystalline forms exist).

FIG. 5 is a scanning electron micrograph of lanthanum oxycarbonate ((LaO)₂CO₃ or La₂CO₅, of which several crystalline forms exist) porous structure made according to the process of the present invention and magnified 60,000 fold.

FIG. 6 is an XRD scan of anhydrous lanthanum oxycarbonate ((LaO)₂CO₃ or La₂CO₅, of which several crystalline forms exist) made according to the process of the present invention and compared with a standard library card of La₂O₂CO₃. The bottom of the figure shows another phase of lanthanum oxycarbonate La₂CO₅.

FIG. 7 is a general flow sheet of a process according to the present invention that produces anhydrous lanthanum oxy-carbonate ((LaO)₂CO₃ or La₂CO₅ of which several crystalline forms exist).

FIG. 8 is a scanning electron micrograph of lanthanum oxycarbonate ((LaO)₂CO₃ or La₂CO₅ or which several crystalline forms exist) porous structure, magnified 80,000 fold.

FIG. 9 is an XRD scan of lanthanum oxycarbonate ((LaO)₂CO₃ or La₂CO₅ of which several crystalline forms exist) as produced and compared with a standard library card of lanthanum oxy-carbonate (La₂O₂CO₃). The bottom of the figure shows another phase of La₂CO₅ (Lanthanum oxycarbonate).

FIG. 10 is a graph comparing the reaction rate of commercial grades of lanthanum carbonate (La₂(CO₃)₃.4H₂O and La₂(CO₃)₃.H₂O), with the reaction rates of the lanthanum oxycarbonate tetra hydrate and the anhydrous oxycarbonates of this invention.

### DESCRIPTION OF THE INVENTION

Referring now to the drawings, the process of the present invention will be described. While the description will generally refer to lanthanum compounds, the use of lanthanum is merely for ease of description and is not intended to limit the invention and claims solely to lanthanum compounds. In fact, it is contemplated that the process and the compounds described in the recent specification are equally applicable to lanthanides and rare earth metals other than lanthanum, such as Ce and Y.

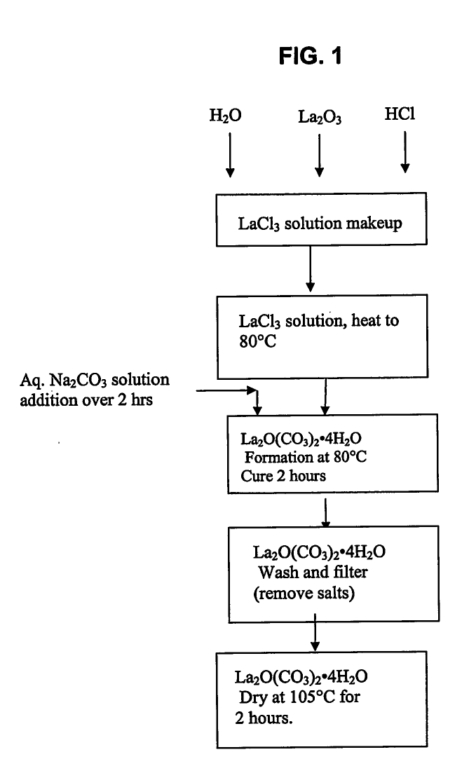

Turning now to FIG. 1, a process for making lanthanum oxycarbonate and in particular, lanthanum oxycarbonate tetrahydrate, is shown. First, an aqueous solution of lanthanum chloride is made by any method. One method to make the solution is to dissolve commercial lanthanum chloride crystals in water or in an HCl solution. Another method to make the lanthanum chloride solution is to dissolve lanthanum oxide in a hydrochloric acid solution.

The LaCl₃ solution is placed in a well-stirred tank reactor. The LaCl₃ solution is then heated to a temperature between 30° C. and 90° C. A previously prepared analytical grade sodium carbonate is steadily added with vigorous mixing. The mass of sodium carbonate required is calculated at 6 moles of sodium carbonate per 2 moles of LaCl₃. When the required mass of sodium carbonate solution is added the resultant slurry or suspension is allowed to cure for about 2 hours at 30 to 90° C. The suspension is then filtered and washed with demineralized water to produce a clear filtrate. The filter cake is placed in a convection oven at 100 to 120° C. for 1 to 5 h or until a stable weight is observed. The initial pH of the LaCl₃ solution is 2, while the final pH of the suspension after cure is 5.5. A white powder is produced. The resultant powder is a lanthanum oxycarbonate hydrate (La₂O(CO₃)₂.xH₂O) where 2≦x≦4, including where x is 3 or 4.

### EXAMPLE I

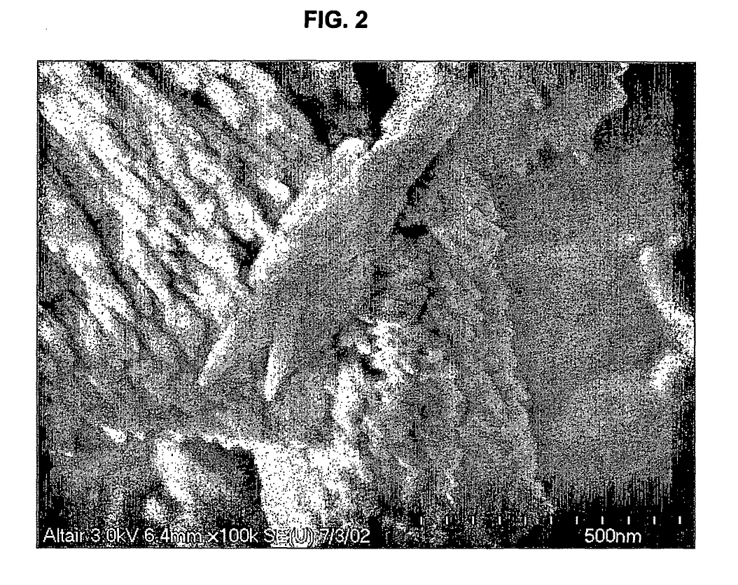

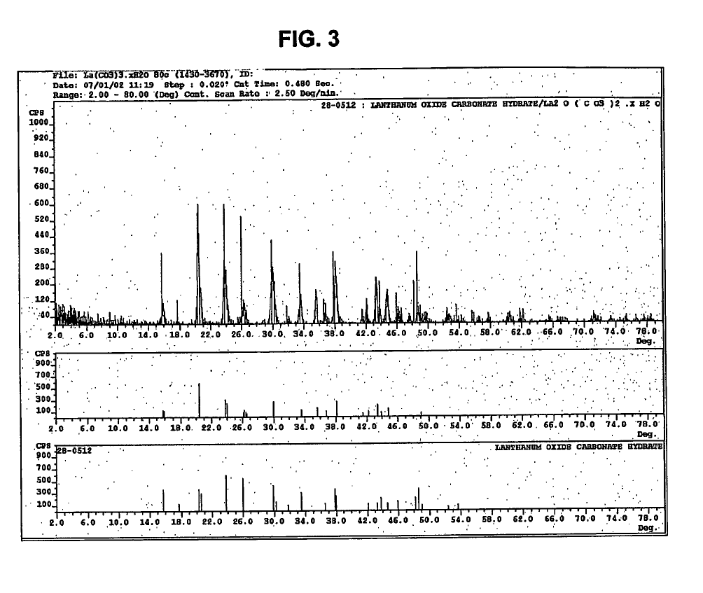

An aqueous solution having a volume of 335 ml and containing lanthanum chloride (LaCl₃) at a concentration of 29.2 weight % as La₂O₃ was added to a 4-liter beaker and heated to 80° C. with stirring. The initial pH of the LaCl₃ solution was 2.2. A volume of 265 ml of an aqueous solution containing 63.6 g of sodium carbonate (Na₂CO₃) was metered into the heated beaker using a small pump at a steady flow rate for 2 h. Using a Buchner filter apparatus fitted with filter paper, the filtrate was separated from the white powder product. The filter cake was mixed 4 times with 2 liters of distilled water and filtered to wash away the NaCl formed during the reaction. The washed filter cake was placed into a convection oven set at 105° C. for 2 h or until a stable weight was observed. FIG. 2 shows a scanning electron micrograph of the product, enlarged 120,000 times. The X-Ray diffraction pattern of the product (FIG. 3) shows that it consists of hydrated lanthanum oxycarbonate La₂O(CO₃)₂.xH₂O, with where 2≦x≦4, including where x is 3 or 4. The sample has a surface area measured by the BET method, of 38.8 m²/g.

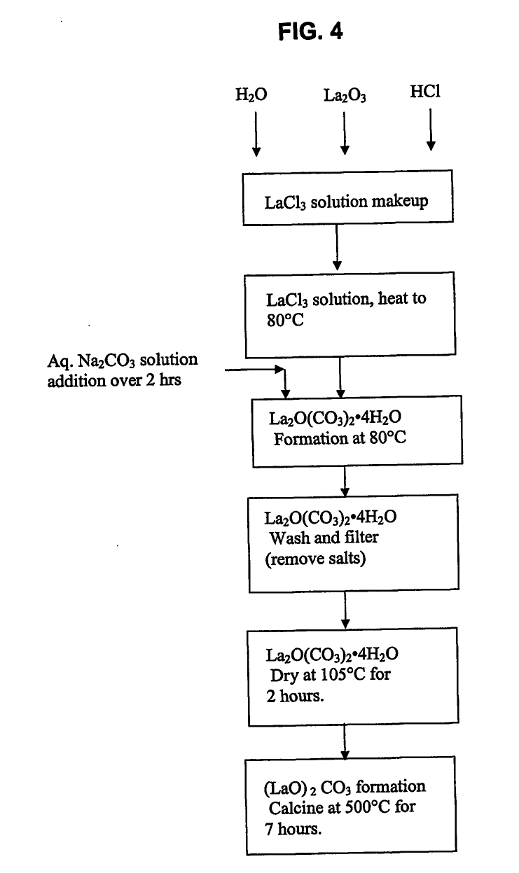

Turning now to FIG. 4, a process for making anhydrous lanthanum oxycarbonate is shown. First, an aqueous solution of lanthanum chloride is made by any method. One method to make the solution is to dissolve commercial lanthanum chloride crystals in water or in an HCl solution. Another method to make the lanthanum chloride solution is to dissolve lanthanum oxide in a hydrochloric acid solution.

The LaCl₃ solution is placed in a well-stirred tank reactor. The LaCl₃ solution is then heated to a temperature between 30 and 90° C. A previously prepared analytical grade sodium carbonate is steadily added with vigorous mixing. The mass of sodium carbonate required is calculated at 6 moles of sodium carbonate per 2 moles of LaCl₃. When the required mass of sodium carbonate solution is added the resultant slurry or suspension is allowed to cure at 30 to 90° C. The suspension is then washed and filtered removing NaCl (a byproduct of the reaction) to produce a clear filtrate. The filter cake is placed in a convection oven at 100 to 120° C. for 1 to 5 hours or until a stable weight is observed. The initial pH of the LaCl₃ solution is 2.2, while the final pH of the suspension after cure is 5.5. A white lanthanum oxycarbonate tetra hydrate powder is produced. Next the lanthanum oxycarbonate tetra hydrate is placed in an alumina tray, which is placed in a high temperature muffle furnace. The white powder is heated to 400 to 700° C. and held at that temperature for 2 to 5 hours. Anhydrous La₂CO₅ is formed. The compound is also designated La₂O₂CO₃ or (LaO)₂CO₃.

### EXAMPLE II

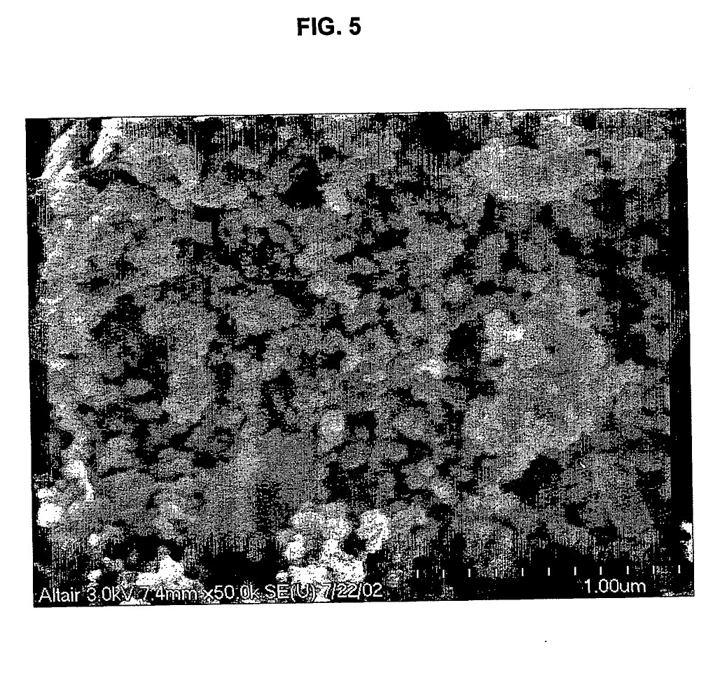

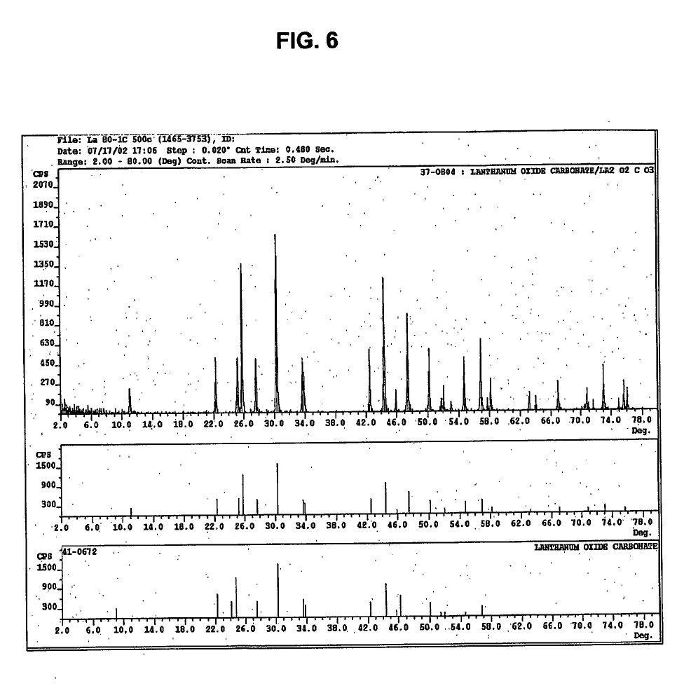

An aqueous solution having a volume of 335 ml and containing lanthanum chloride (LaCl₃) at a concentration of 29.2 weight % as La₂O₃ was added to a 4-liter beaker and heated to 80° C. with stirring. The initial pH of the LaCl₃ solution was 2.2. A volume of 265 ml of an aqueous solution containing 63.6 g of sodium carbonate (Na₂CO₃) was metered into the heated beaker using a small pump at a steady flow rate for 2 h. Using a Buchner filter apparatus fitted with filter paper, the filtrate was separated from the white powder product. The filter cake was mixed 4 times with 2 liters of distilled water and filtered to wash away the NaCl formed during the reaction. The washed filter cake was placed into a convection oven set at 105° C. for 2 h or until a stable weight was observed. Finally, the lanthanum oxycarbonate was placed in an alumina tray in a muffle furnace. The furnace temperature was ramped to 500° C. and held at that temperature for 3 h. The resultant product was determined to be anhydrous lanthanum oxycarbonate La₂O₂CO₃, with a surface area of 27 m²/g. FIG. 5 shows a scanning electron micrograph of the product, enlarged 60,000 times. The X-Ray diffraction pattern of the product (FIG. 6) shows that it consists of anhydrous lanthanum oxycarbonate La₂O₂CO₃.

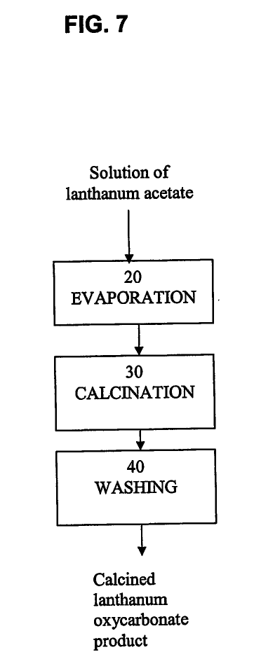

Turning now to FIG. 7, another process for making anhydrous lanthanum carbonate is shown. First, a solution of lanthanum acetate is made by any method. One method to make the solution is to dissolve commercial lanthanum acetate crystals in water or in an HCl solution. Another method to make the lanthanum acetate solution is to dissolve lanthanum oxide in an acetic acid solution.

The product solution is further evaporated to form an intermediate product. The evaporation 20 is conducted under conditions to achieve substantially total evaporation. In particular, the evaporation is conducted at a temperature higher than the boiling point of the feed solution but lower than the temperature where significant crystal growth occurs. The resulting intermediate may desirably be an amorphous solid formed as a thin film and may have a spherical shape or a shape in part of a sphere.

The term “substantially total evaporation” or “substantially complete evaporation” refers to evaporation such that the solid intermediate contains less than 15% free water, preferably less than 10% free water, and more preferably less than 1% free water. The term “free water” is understood and means water that is not chemically bound and can be removed by heating at a temperature below 150° C. After substantially total evaporation or substantially complete evaporation, the intermediate product will have no visible moisture present.

The evaporation process may be conducted in a spray dryer. In this case, the product will consist of a structure of spheres or parts of spheres. The spray dryer generally operates at a discharge temperature between about 120° C. and 500° C.

The intermediate product may then be calcined 30 by raising the temperature to a temperature between about 400° C. to about 800° C. for a period of time from about 2 to about 24 h and then cooled to room temperature. The cooled product may be washed 40 by immersing it in water or dilute acid, to remove traces of any water-soluble phase that may still be present after the calcination step.

The temperature and the length of time of the calcination process may be varied to adjust the particle size and the reactivity of the product.

The particles obtained after calcination and washing have been used to efficiently remove phosphate from water. The particles may also be used in a device to directly remove phosphate from water.

The particles generally have a size between 1 and 1000 μm. The particles consist of individual crystals, bound together in a structure with good physical strength. They form a porous structure. The individual crystals generally have a size between 20 nm and 10 μm. If the evaporation process is conducted in a spray-dryer, the particles consist of spheres or parts of spheres.

### EXAMPLE III

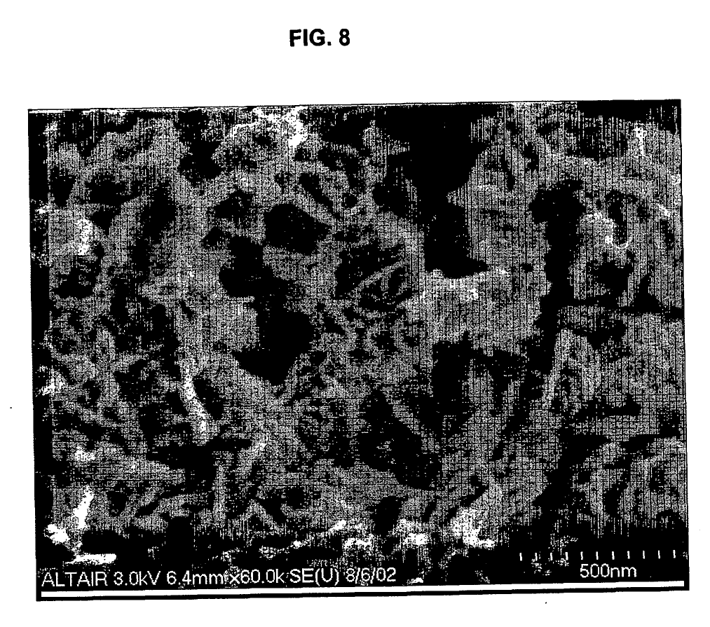

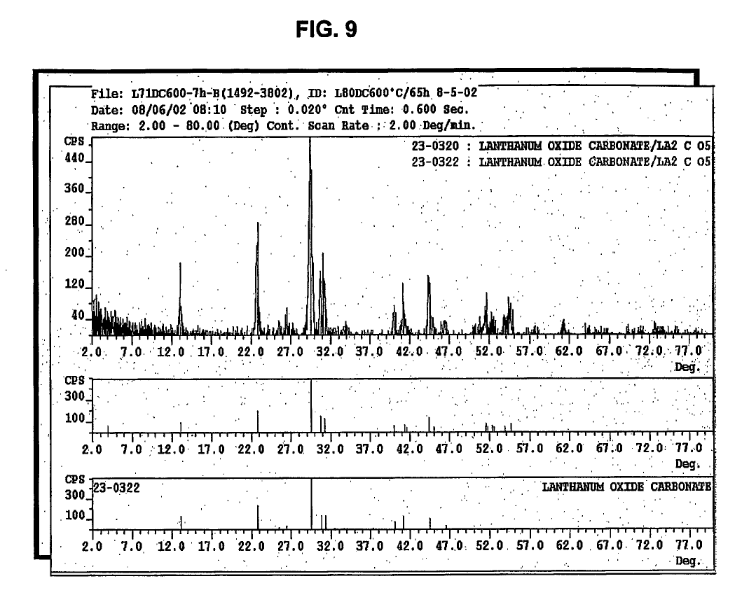

A solution containing 100 g/l of La as lanthanum acetate is injected in a spray dryer with an outlet temperature of 250° C. The intermediate product corresponding to the spray-drying step is recovered in a bag filter. This intermediate product is calcined at 600° C. for 4 h. FIG. 8 shows a scanning electron micrograph of the product, enlarged 60,000 times. The X-Ray diffraction pattern of the product (FIG. 9) shows that it consists of anhydrous lanthanum oxycarbonate La₂CO₅. The surface area of the sample, measured by the BET method, was 25 m²/g.

### EXAMPLE IV

To determine the reactivity of the lanthanum compounds with respect to phosphate, the following tests were conducted. A stock solution containing 13.75 g/l of anhydrous Na₂HPO₄ and 8.5 g/l HCl was prepared. The stock solution was adjusted to pH 3 by the addition of concentrated HCl. An amount of 100 ml of the stock solution was placed in a beaker with a stirring bar. In separate experiments, the lanthanum oxycarbonates corresponding to Examples I, II and III of the present invention were added to the solution. The amount of lanthanum oxycarbonate or carbonate was such that the amount of La in suspension was 3 times the stoichiometric amount needed to react completely with the phosphate. Samples of the suspension were taken at time intervals through a filter that separated all solids from the liquid. The liquid samples were analyzed for phosphorous.

Two further experiments were run in the same conditions as those given in the previous paragraph, except that commercial lanthanum carbonate tetra hydrate La₂(CO₃)₃.4H₂O in one case, commercial lanthanum carbonate monohydrate La₂(CO₃)₃.H₂O in the other case, were added to the solution.

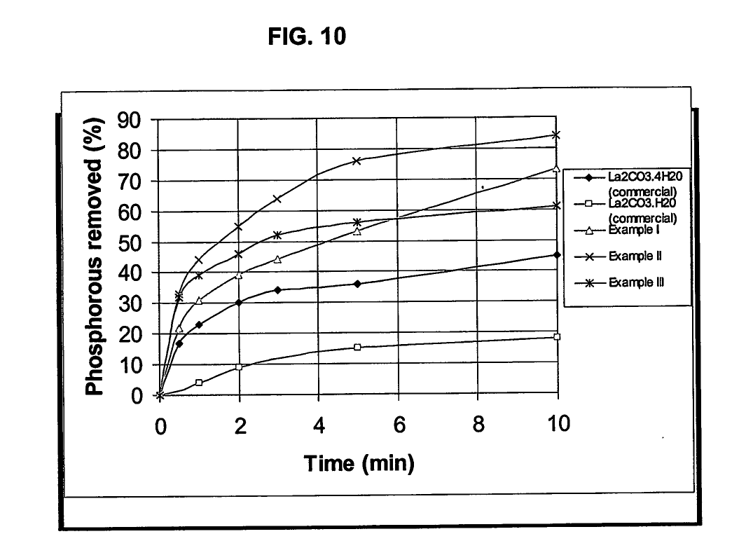

Curves showing the amount of phosphorous removed from the solution as a function of time with the different lanthanum compounds are given in FIG. 10. The figure shows that the rate of removal of phosphate with the different oxycarbonates of this invention is faster than the rate of removal obtained for commercial lithium carbonate tetra hydrate or monohydrate.

The particles of lanthanum oxycarbonate made according to the process of the present invention, particularly those made following the methods corresponding to Example II and Example III have the following common properties:
They have low solubility in water.
Their hollow shape gives them a high surface area, providing a fast reaction rate, while the particles themselves are aggregates large enough to be collected on ordinary water filters.
They have faster phosphate binding kinetics than commercial grade lanthanum carbonates, as shown in FIG. 10.

Because of these characteristics, the products of the present invention have the potential to be used to remove phosphates from swimming pools and other water systems more efficiently than existing compositions and methods. Particularly, the products of the present invention have the potential of faster removal of phosphates without forming small, unfiltrable precipitate and without leaving unreacted La salts in solution, and to be used directly in the filtration system of a swimming pool. The oxycarbonate compounds are safe and do not need flocculants or ordinary chemicals. No pool downtime is needed to use them.

While the invention has been described in conjunction with specific embodiments, it is to be understood that many alternatives, modifications, and variations will be apparent to those skilled in the art in light of the foregoing description. Accordingly, this invention is intended to embrace all such alternatives, modifications, and variations that fall within the spirit and scope of the appended claims.

What is claimed:

1. A rare-earth compound selected from the group consisting of rare earth anhydrous oxycarbonate and rare earth hydrated oxycarbonate, with a surface area of at least 10 m²/g, suitable for the removal of phosphate from water.

2. A rare-earth compound selected from the group consisting of rare earth anhydrous oxycarbonate and rare earth hydrated oxycarbonate, manufactured as agglomerates of 1 to 1000 μm in size, suitable for the removal of phosphate from water.

3. The compound of claim 1 or 2, where the rare earth is selected from the group consisting of lanthanum, cerium and yttrium.

4. The compound of claim 1 or 2, where the rare earth is lanthanum.

5. The compound of claim 1 or 2, where the compound is a particle with a porous structure.

6. The compound of claim 5, where the porous structure is made by total evaporation of a rare-earth salt solution, followed by calcination.

7. The compound of claim 6, where the total evaporation step is conducted in a spray dryer.

8. The compound of claim 6, where the evaporation temperature is between about 120° and 500° C.

9. The compound of claim 6, where the calcination temperature is between about 400° and about 1200° C.

10. The compound of claim 6, where the porous particles have a size between 1 and 1000 μm.

11. The compound of claim 10, where the particles are formed from individual crystals having a size between 20 nm and 10 μm.

12. The compound of claim 7, where the product is made of spheres or parts of spheres.

13. The compound of claim 6 wherein the rare earth salt solution is a rare earth acetate.

14. The compound of claim 6 wherein the rare earth salt solution is neutralized with sodium carbonate, followed by washing, filtering and drying.

15. The compound of claim 14 wherein the neutralization process takes place at a temperature between 30° and 90° C.

16. The compound of claim 15 wherein the drying takes place at a temperature of about 100° to 120° C.

17. The compound of claim 16 wherein the drying takes place for a period of about 1 to 5 h.

18. A method of preventing algal growth in swimming pools and other water systems comprising providing an effective amount of the compound of claim 1 or 2.

19. The method of claim 17 wherein the compound exhibits a low solubility in water.

20. The method of claim 17 wherein the compound is added in the filtration system of a swimming pool.
